(19) United States
(12) Patent Application Publication
(10) Pub. No.: US 2017/0008604 A1
(43) Pub. Date: Jan. 12, 2017

(54) Underwater Alert Device with Shark Deterrent

(71) Applicant: David Buster, Raleigh, NC (US)

(72) Inventor: David Buster, Raleigh, NC (US)

(21) Appl. No.: 14/794,910

(22) Filed: Jul. 9, 2015

(51) Int. Cl. B63C 11/26; A01K 79/02

(52) U.S. Cl. CPC B63C 11/26; A01K 79/02

(57) ABSTRACT

This document presents a multiple alert and deterrent device that may be used in underwater environments to present visual and audio signals to alert other divers, and simultaneously generate a voltage that serves as a deterrent to sharks. The activation of all alert and deterrent components occurs simultaneously when a user activates the device. Device activation may occur as the result of a user selection, or may be configured to occur automatically when a user removes the device from a connection to the user's clothing or any equipment associated with the user to which the device is attached.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Scuba divers and other underwater workers require alert devices that work in an environment that is more difficult for human senses to overcome in order to receive signals and information, especially in attempting to attract the attention of another person while underwater. Various methods and types of alert devices are available permitting underwater adventurers and workers to attract and maintain the attention of others while underwater.

Miniaturization of underwater alert devices frequently sacrifices usability for size. However, handheld alert devices, which must be small enough to carry and be out of the way, yet powerful enough to perform an underwater alert function, rely on miniaturization of more powerful alert devices. As a result, handheld alert devices typically focus on performing one style of alert very well, sometimes resulting in an underwater adventurers and workers carrying multiple devices for various alerts or forgo carrying such alert devices at all.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of a multiple alert device consistent with certain embodiments of the present invention.

FIG. 2 is a view of an internal cross-section of a multiple alert device consistent with certain embodiments of the present invention.

FIG. 3 is a view of a multiple alert device having an attachment component consistent with certain embodiments of the present invention.

FIG. 4 is a view of a multiple alert device with lanyard carrying component consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Reference throughout this document to “alert device” refers to any device such as, but not limited to, a video, audio, electrical or any other device a user may carry when underwater to provide alert and other communications to other persons.

In an exemplary embodiment, underwater alert devices are required to be waterproof and perform reliably when underwater. Additionally, such underwater alert devices may be required to operate reliably after long periods of disuse, or to work on a moment's notice. The requirements for reliable use and proof against water intrusion are difficult enough for an alert device that must provide a single alert function. However, a single alert function is frequently insufficient to reliably transmit an alert signal from one person to another when underwater. For example, it is easy for a second diver to be looking away from a first diver who triggers a visual alert signal, such as a strobing light, and miss the signal entirely. In a second example, it is often difficult to determine from where a sound is originating when the alert signal is an audio signal, without some other signal coupled with the sound alert. In a further complication, sometimes an alert signal is insufficient to counter a danger while underwater, such as a close approach, or even an attack, from a predatory fish, such as a shark. As a result, a need exists for an underwater alert device that may provide multiple alert types, as well as function as a deterrent to predatory underwater creatures such as sharks.

In an exemplary embodiment, a multiple alert device may combine three separate functions, each as a portion of the multiple alert device, in a novel way to provide safety and security for underwater adventurers and workers such as scuba divers, swimmers, snorkelers, construction workers, or any other people who participate in underwater recreation or make their living under water. These portions may consist of:
1) a sound generating portion capable of being heard under water
2) a light emitting portion capable of being seen under water
3) an electronic shark deterrent portion.

In this exemplary embodiment, all three of these functions may be activated and used simultaneously as each portion of the multiple alert device responds to an activation signal from a user. The sound generating portion alerts other divers and/or swimmers of an emergency situation. However, because it is difficult to locate sources of sound underwater, the light emitting portion may then assist others in locating the source of the alert. The sound generating portion and the light emitting portion work in combination to not only transmit an audio alert tone, but to also identify the source of the alert tone by emitting a light visible underwater. Finally, in the event that a shark is near, the electronic shark deterrent portion emits a voltage sufficient to drive a shark away. In this exemplary embodiment, a single activation action by a user is sufficient to initiate both audio and visible alerts and the shark deterrent voltage.

In an embodiment, the multiple alert device is water-proof and battery powered to provide reliable functionality in an underwater setting. The multiple alert device is also of a sufficient compact size and light enough in weight to permit a user to readily carry one or more devices on their person while underwater. In a non-limiting example, the functions of the device may be activated readily through the use of a single switch activation. The switch may be a magnetic switch, a physical toggle switch, a mechanical switch, or any other single touch mechanism. The switch activation by the user causes all three functions, in this non-limiting example, the audio alert, visual alert, and the voltage generator, to be activated simultaneously. The device may be hand-held, but the length of versions of the device may vary from 6 inches (15.24 cm) to 6.5 feet (2 meters) without any change in the functionality of the alerts and voltage deterrent. In an additional exemplary embodiment, the length of the multiple alert device may be increased or decreased by manufacturing the case in a series of separate sections, the section containing the alert portions the largest and each additional section slightly smaller than an adjacent section such that the sections slide into one another so as to modify the length of the multiple alert device. This exemplary construction permits the case of the multiple alert device to telescope into a more compact configuration or a longer configuration based upon a user's need. In a non-limiting example, the multiple alert device may be manufactured having sheaths or exterior cases of different colors and textures to differentiate units when multiple units are in use in a single group of users.

In an exemplary embodiment, the sound emitting portion of the multiple alert device may consist of a transducer. In this embodiment, the transducer, when activated, will be loud enough to be heard underwater, but not so loud as to cause hearing distress to humans in the vicinity. The transducer may preferentially operate at a frequency between 3000 and 4000 Hertz, which is near the center of human hearing sensitivity. In an exemplary embodiment, the sound may be continuous, may consist of regularly spaced pulses, or may consist of a pattern of pulses to indicate identity or specific alert messages.

In this exemplary embodiment, the light emitting portion of the multiple alert device may be bright enough to be seen in clear water to a nominal distance of 20 feet. The water turbidity may impact the ability to see the light from the light portion of the multiple alert device, however. The visual alert may consist of a continuous light emission or the light emitting portion may flash at a rate of one to 10 times per second. Additionally, the color of the emitted light may be fixed as a particular portion of the human visual range or the light may vary through a pre-determined set of portions of the human visual range to serve as a signal to allow identification of unique users. The light emitting portion may also use an adjustable pattern or rhythm of pulses of varying lengths of time to indicate identity or a specific message, or to identify individual divers and/or threats.

In an embodiment, the multiple alert device comprises not only audio and visual alert portions, but also consists of a shark deterrent portion that may be activated simultaneously with the visual and audio alert portions. The shark deterrent portion may consist of a voltage introduced into the water which is detected by sense organs in a shark's snout called the “Ampules of Lorenzini”. Because sharks are extremely sensitive to voltage, it is possible to emit a voltage that is strong enough to deter a shark, while still being safe for humans in the water. In a preferred embodiment, this voltage is in a range of approximately 50-150 volts. In addition to a preferred voltage range, the voltage may be pulsed or continuous to both permit greater control over the range of the deterrent effect, but also to provide for longer battery life while in use.

In additional embodiments, the multiple alert device may also provide for attachment to a user through a non-metallic hook-and-eye portion attached to the exterior of the multiple alert device and the diving or bathing suit of the user. One half of the hook-and-eye attachment may be securely fastened, through a water-proof glue or other attachment form, with the other half of the hook-and-eye attachment fastened to the bathing or diving suit of the user such that the device may be securely, but removeably attached to the user when the two halves of the hook-and-eye attachment portion are brought into contact.

In an alternative embodiment, a lanyard may be affixed to the exterior of the case of the multiple alert device such that the lanyard may be looped around the wrist of the user, or around a device associated with the user. In this manner, the lanyard will permit the multiple alert device to be removeably attached to the user, but also permit use of the multiple alert device without having to detach the multiple alert device from the person of the user prior to use. The multiple alert device may also have an adjustable buoyancy feature. The adjustable buoyancy permits the multiple alert device to float above a user's head when the buoyancy is positive, or permit the multiple alert device to be suspended below a user on the surface when the buoyancy is negative. In an additional non-limiting embodiment, the multiple alert device may contain a magnetically activated switch. The magnetically activated switch is operable to activate the multiple alert device so that when it is pulled away from the attachment device, such as the hook-and-eye or magnetic attachment as previously described all of the alert and deterrent functions may activate automatically.

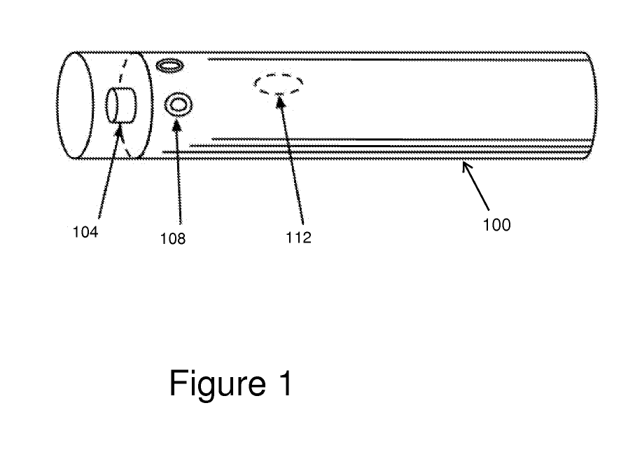

Turning now to FIG. 1, this figure presents a view of a multiple alert device consistent with certain embodiments of the present invention. In an exemplary embodiment, the multiple alert device comprises a case 100 that is sealed against water intrusion making the multiple alert device substantially waterproof. The case 100 may be cylindrical in shape and of a sufficient diameter to be held easily in the hand of a user and contain the activation components for each of the alert and deterrent portions of the multiple alert device. In an exemplary embodiment, the multiple alert device is operable to activate a light alert 104, voltage deterrent 108, and visible alert 112 simultaneously upon engaging an activation switch. The activation switch may be a magnetic switch, contact switch, toggle switch, or any other switch that may perform a toggle function and be made waterproof.

The case 100 of the multiple alert device may be composed of a visually opaque material, such as, in a non-limiting embodiment, plastic, rubber, acrylic, aluminum, steel, or any other material suitable for use underwater. The case 100 may also have a visually transparent end portion 116 in which a light alert may be installed. The transparent end portion 116 may be provided to permit the light from the visual alert 104 to be seen when the multiple alert device is activated, yet provide a section that may be removable so as to provide access to the internal portion of the case 100 to permit changing a light source, battery, or other portions of the multiple alert device. The transparent end portion 116 may have a waterproof seal to permit the removal of the transparent end portion 116 and reattachment such that the multiple alert device may be openable so as to maintain the internal portions of the device, yet regain waterproof integrity after the transparent end portion is reattached to the case 100.

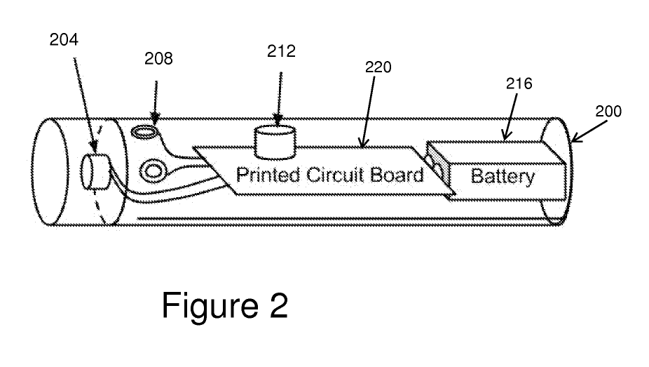

Turning now to FIG. 2, this figure presents a view of an internal cross-section of a multiple alert device consistent with certain embodiments of the present invention. In an exemplary embodiment, the multiple alert device comprises a cylindrical case 200 within which are installed the components needed to activate and control a visual alarm 204, a voltage generated as a shark deterrent 208, and an audio alert 212. Each alert and deterrent element is contained within the case 200 and the case is substantially waterproof to permit electrical and electronic signals and devices to perform their functions when the multiple alert device is submerged in water. The case 200 of the multiple alert device encloses a battery 216 that supplies power to all of the alert and deterrent features of the multiple alert device. The case 200 also encloses a printed circuit element 220 comprising a processor having timing and activation logic installed in the processor either through software download or built into the logical circuits of the processor generated specifically for the multiple alert device. Although a general purpose, industrial processor may be installed on the printed circuit card 220, the software loaded onto the general purpose processor may be specific to the functioning and control of the multiple alert device. In this exemplary embodiment, the voltage range produced by the voltage producing element may be in the range of 50 to 150 volts, however, a user may preferentially select any voltage within this range of operation and that voltage level will be automatically generated each time the device is activated.

In an exemplary embodiment, the printed circuit element 220 may also have electrical connections to the battery 216 to provide power for the processor, activation, and control of the alert and deterrent elements of the multiple alert device. The printed circuit element 220 may also have electrical connections to the visual signal alert portion 204, where the light emitting element may consist of an LED, incandescent, or other light emitting bulb, to permit the activation of the visual alert by providing power to the light emitting element. Additionally, the processor on the printed circuit element 220 may be operable to activate and deactivate the power supplied to the visual signal alert portion 204, so as to provide particular patterns of light emitted such that these patterns may provide a consistent strobing of emitted light, or particular patterns associated with an alert condition or a person. Similarly, the processor on the printed circuit element 220 may be operable to provide activation signals and power to the voltage deterrent portion 208, and the audio alert portion 212. Just as with the visual alert portion 204, the processor may provide particular patterns of activation and deactivation signals, through completing the electrical connection to the battery 216, so as to provide constant or particular patterns of activation and deactivation that may be associated with particular alerts or particular persons.

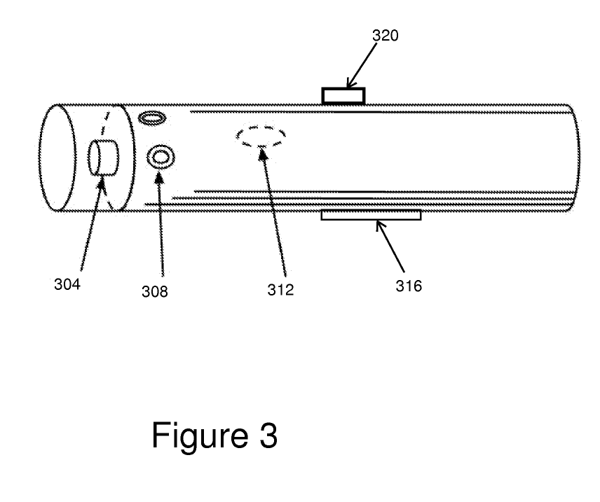

Turning now to FIG. 3, this figure presents a view of a multiple alert device having an attachment component consistent with certain embodiments of the present invention. In an exemplary embodiment, a multiple alert device may be attached to the clothing or equipment associated with a user. This attachment device 316 may be in the form of a magnetic device, a hook-and-eye fastener, or any other attachment device that permits the detachment and reattachment of the multiple alert device to the user.

In an exemplary embodiment, the attachment device 316 may be connected magnetically to an internal magnet reed switch (not shown) such that when the user detaches the multiple alert device from their clothing or other equipment, the attachment device 316 closes a contact within the multiple alert device and causes the processor to activate the visual alert portion 304, voltage deterrent portion 308, and audio alert portion 312 simultaneously. The magnetic reed switch (not shown) would permit the deactivation of the multiple alert device upon reattachment to the clothing or equipment of the user.

Alternatively, the attachment device 316 may be a hook-and-eye fastener in which a first portion would be attached to the multiple alert device, and a second portion attached to the clothing or equipment of the user. When the multiple alert device is detached from the user's clothing or equipment, the user could then manually activate the multiple alert device by pressing the activation button 320. The user could also then manually deactivate the multiple alert device by pressing the activation button 320 a second time to toggle the multiple alert device to an off status.

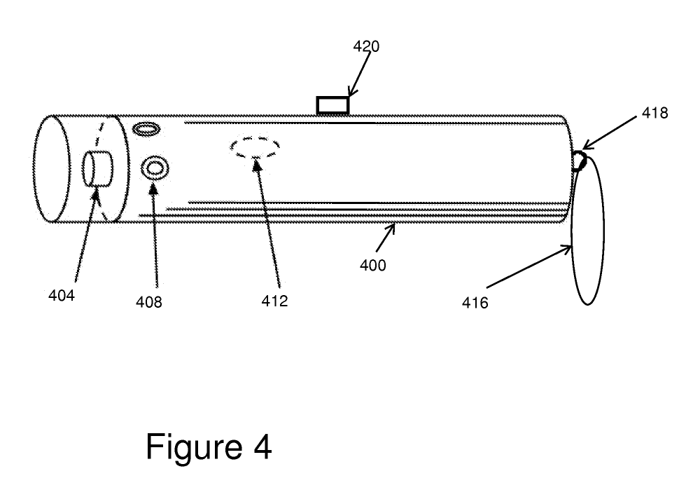

Turning now to FIG. 4, this figure presents a view of a multiple alert device with lanyard carrying component consistent with certain embodiments of the present invention. In an exemplary embodiment, a multiple alert device may be attached to the clothing or equipment associated with a user. This attachment device 416 may be in the form of a lanyard that permits the detachment and reattachment of the multiple alert device to the user.

In an exemplary embodiment, the attachment device 416 may be connected to an eyelet 418 attached to the case 400 such that user may loop the attachment device 416 around a user's wrist, ankle, or other body part or piece of equipment associated with the user. The user may move about freely underwater with the multiple alert device remaining close through the connection with the attachment device 416. When needed, the user could pull the device toward themselves through the use of the lanyard as the attachment device 416 and manually activate the visual alert portion 404, voltage deterrent portion 408, and audio alert portion 412 simultaneously by pressing the activation button 420. The user could also then manually deactivate the multiple alert device by pressing the activation button 420 a second time to toggle the multiple alert device to an off status.

While certain illustrative embodiments have been described, it is evident that many alternatives, modifications, permutations and variations will become apparent to those skilled in the art in light of the foregoing description.

What is claimed is:

1. A device, comprising:
a case;
a sound generation element;
a light emitting element;
a voltage producing element;
where the sound generation, light emitting element, and voltage producing element are all enclosed within the case and operate simultaneously.

2. The device of claim 1, where the case is waterproof and protects all elements contained within the device from interaction with water.

3. The device of claim 1, where the sound generation element is pre-configured to produce particular patterns of sound based upon user preferences.

4. The device of claim 1, where the light emitting element is pre-configured to produce pulses of light and light pulse patterns according to user preferences and personalization.

5. The device of claim 1, where the voltage producing element creates a steady voltage or a pre-configured voltage pulse according to user design.

6. The device of claim 5, where the voltage producing element creates a voltage in the range of approximately 50 to approximately 150 volts.

7. The device of claim 1, where the simultaneous operation of all elements of the device occurs upon activation of the device by a user.

8. The device of claim 7, where activation of the device is accomplished when a user pushes a button on the exterior surface of the case.

9. The device of claim 7, where activation of the device occurs automatically when a user removes the device from a connection to the user's clothing or other equipment associated with the user.

10. The device of claim 6, where the voltage producing element creates a user selected voltage that is automatically generated each time the device is activated.
